(19) United States
(12) Patent Application Publication
(10) Pub. No.: US 2013/0184135 A1
(43) Pub. Date: Jul. 18, 2013

(54) METHOD FOR FOLDING BLANKS OF CORRUGATED BOARD FOR THE PRODUCTION OF FOLDING BOXES, AND APPARATUS FOR FOLDING THE CORRUGATED BOARD BLANKS

(71) Applicant: FLATZ VERPACKUNGEN - STYROPOR GMBH, Lauterach (AT)

(72) Inventor: ANDREAS DUER, LOCHAU (AT)

(73) Assignee: FLATZ VERPACKUNGEN - STYROPOR GMBH, LAUTERACH (AT)

(21) Appl. No.: 13/715,210

(22) Filed: Dec. 14, 2012

(30) Foreign Application Priority Data
Jan. 12, 2012 (AT) A 29/2012

(51) Int. Cl. B31B 1/26

(52) U.S. Cl. CPC B31B 1/26
USPC 493/162

(57) ABSTRACT

A method and system for folding blanks of corrugated board for the production of folding boxes. The blanks are formed with fold-line structuring such as grooves, scores, perforations or the like aligned at least approximately parallel to the course of the corrugations of the corrugated board and possibly also at right angles thereto. The board can be folded or bent along the fold-line structuring. In the region of at least some of the grooves, scores, perforations or the like aligned at least approximately parallel to the course of the corrugations of the corrugated board along which folding is carried out, a liquid is introduced before the folding operation, as a result of which the corrugated board in the region of the fold-line structuring is made flexible.

### CROSS-REFERENCE TO RELATED APPLICATION

This application claims the priority, under 35 U.S.C. § 119, of Austrian patent application A 29/2012, filed Jan. 12, 2012; the prior application is herewith incorporated by reference in its entirety.

### BACKGROUND OF THE INVENTION

### Field of the Invention:

The present invention relates to a method for folding blanks that consist of corrugated board for the production of folding boxes, the blanks being formed with grooves, scores, perforations or the like aligned at least approximately parallel to the course of the corrugations of the corrugated board, and possibly also at right angles thereto, along which folding or bending can be carried out.

The present invention further relates to an installation, or apparatus, for folding blanks of corrugated board for the production of folding boxes.

During the production of folding boxes consisting of corrugated board, use is made of blanks which are provided with grooves, scores, perforations or the like aligned at least approximately parallel to the course of the corrugations. The blanks are then folded or bent along these lines in order in this way to produce folding boxes, for example with a bottom face, a peripheral face and a top face. Furthermore, parts assigned to one another are provided on the peripheral face of the folding boxes, which parts are joined to one another, in particular adhesively bonded.

Corrugated boards consist, for example, of two flat paper webs, between which there is a corrugated paper web. This is what is known as a single-layer or single corrugated board.

A two-layer or double corrugated board consists of two flat paper webs located on the outside, a flat paper web on the inside and two corrugated paper webs disposed on both sides of the inner flat paper web and within the two outer flat paper webs.

Furthermore, corrugated boards having three corrugated paper webs are also known, the latter being located within two flat paper webs, flat paper webs also being located between the corrugated paper webs in each case. These are designated three-layer or triple corrugated boards.

In corrugated boards, a distinction is also drawn between different types of corrugations and combinations of these types of corrugations, a distinction being drawn between a coarse corrugation, a medium corrugation, a fine corrugation and a micro corrugation, depending on the corrugation height, or amplitude, and the corrugation pitches, and so on.

In order to achieve the necessary stacking strength of the folding boxes in folding boxes made of corrugated board, the corrugated board is arranged such that, in the peripheral faces of the folding boxes, the corrugations run from the bottom face to the top face and, respectively, the channels formed by the corrugations also run between the bottom face and the top face of the folding box.

In order to provide the peripheral face with the necessary folds and bends and to be able to connect the mutually assigned parts of the peripheral face to each other, grooves, scores, perforations or the like aligned parallel to the course of the corrugations have to be provided in the peripheral face, along which the peripheral face can be folded or bent between the individual side faces of the folding box. Here, the fact arises that the grooves, scores, perforations or the like can be located along a corrugation valley, along a corrugation peak or along the flank between a corrugation valley and a corrugation peak. This means that, because of the stiffness of the material, the subsequent folding is not carried out exactly along the line required for this purpose. Instead, deviations from the predefined fold line occur, which consequently lead to the joining of the two mutually assigned end regions of the peripheral faces not being carried out at the correct point.

The problem that the folding is not carried out exactly along a predefined line is referred to as “fishtailing.” The inaccuracy caused hereby at the point of closure of the peripheral face is designated a “gap.” These disadvantageous effects occur in the case of double corrugated and triple corrugated boards and to an increased extent in poor qualities of the papers used for production of the corrugated board. As a result of these effects, the dimensional accuracy of the folding boxes is reduced, which fact is disadvantageous in particular during the automatic filling of the folding boxes.

### SUMMARY OF THE INVENTION

It is accordingly an object of the invention to provide a method and apparatus for folding blanks of corrugated board into folding boxes which overcomes the above-mentioned and other disadvantages of the heretofore-known devices and methods of this general type.

With the foregoing and other objects in view there is provided, in accordance with the invention, a method for folding blanks of corrugated board for the production of folding boxes, the method which comprises:
providing the folding blanks with fold-line structuring defining folding locations at which the corrugated board is to be folded or bent, the fold-line structuring being selected from the group consisting of grooves, scores, and perforations aligned substantially parallel to, or perpendicular to, a course of corrugations of the corrugated board;
applying a liquid to at least some of the fold-line structuring prior to a folding operation to thereby render the corrugated board relatively more flexible at the respective fold-line structuring than remaining parts of the corrugated board.

In other words, the objects are achieved, in a method for folding blanks for the production of folding boxes, in that, in the region of at least some of the fold-line structuring (e.g., grooves, scores, perforations, or the like) aligned at least approximately parallel to the course of the corrugations of the corrugated board along which folding is carried out, a liquid is introduced before the folding operation, as a result of which the corrugated board in the region of these grooves, scores, perforations or the like is made flexible.

The fact that the material located in the region of the grooves, scores, perforations or the like is made flexible as a result of wetting means that the subsequent folding is carried out exactly along the line provided for this purpose, irrespective of the region of the corrugation in which it is made, which means that the blanks are folded exactly and the closure is carried out exactly at the correct point on the peripheral face. In this way, the detrimental effects designated “fishtailing” and “gap” in the production of semifinished products for the production of folding boxes are thus avoided, by which means the quality of these semifinished products is increased substantially with regard to the dimensional accuracy thereof. A high dimensional accuracy is important in particular for the automatic filling of folding boxes.

The liquid is preferably sprayed into the grooves, scores, perforations or the like. In particular, a liquid is used which penetrates the corrugated board within a short time. Here, the term “short time” is to be understood as a relative term. The composition of the liquid depends on the composition of the cardboard, and especially on the cover sheet(s) of the board. That is, the liquid is maximized with regard to its permeability (and soakability) into the board. This liquid preferably consists of a mixture of water and an alcohol, such as ethanol or petroleum ether (surgical spirit), wherein the water has a proportion of 20% by volume to 80% by volume, in particular of about 50% by volume, and the alcohol has a proportion from 80% by volume to 20% by volume, in particular of about 50% by volume. In particular, distilled water is used.

A system for folding the blanks for the production of folding boxes consisting of corrugated board, the blanks being formed with grooves, scores, perforations or the like aligned at least approximately parallel to the course of the corrugations and possibly also at right angles thereto, along which folding or bending can be carried out, has an apparatus for folding the blanks along some of the grooves, scores, perforations or the like aligned parallel to the course of the corrugations, wherein, according to the invention, at least one apparatus for introducing a liquid into the region of at least some of the grooves, scores, perforations or the like aligned at least approximately parallel to the course of the corrugations of the corrugated board, along which folding is carried out, is arranged upstream of the apparatus for folding the blanks.

In particular, by means of this apparatus, the liquid is sprayed into the grooves, scores, perforations or the like.

Preferably, by means of the apparatus for introducing a liquid, a liquid by which the corrugated board is penetrated within a short time is applied.

This penetration is achieved in particular by a mixture of preferably distilled water and an alcohol, such as ethanol or petroleum ether (surgical spirit).

Preferably, a system according to the invention is constructed with an apparatus by means of which the grooves, scores, perforations or the like aligned at least approximately parallel to the course of the corrugations are produced in the blanks. Furthermore, this system can also have an apparatus by means of which the two mutually assigned end parts of the peripheral face are joined to each other. In particular, this system can have an apparatus by means of which an adhesive is applied to at least one of the two mutually assigned end parts of the peripheral face that are used to produce the closure of the peripheral face, and it further has an apparatus by means of which, by folding the peripheral face, the mutually assigned end parts of the peripheral face are brought into contact with each other and adhesively bonded to each other as a result.

Other features which are considered as characteristic for the invention are set forth in the appended claims.

Although the invention is illustrated and described herein as embodied in a method for folding blanks consisting of corrugated board for the production of folding boxes, and system for the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a plan view onto a blank made of corrugated board;

FIG. 1A is a perspective view of a partly assembled folding box produced from the blank according to FIG. 1;

FIG. 2 is a perspective view of an apparatus, or assembly system for folding blanks according to FIG. 1, configured to stack the blanks on a pallet; and

FIG. 2A is a side view of a detail from the assembly system according to FIG. 2, as viewed in the direction of the arrow B of FIG. 2 and enlarged with respect to FIG. 2.

### DETAILED DESCRIPTION OF THE INVENTION

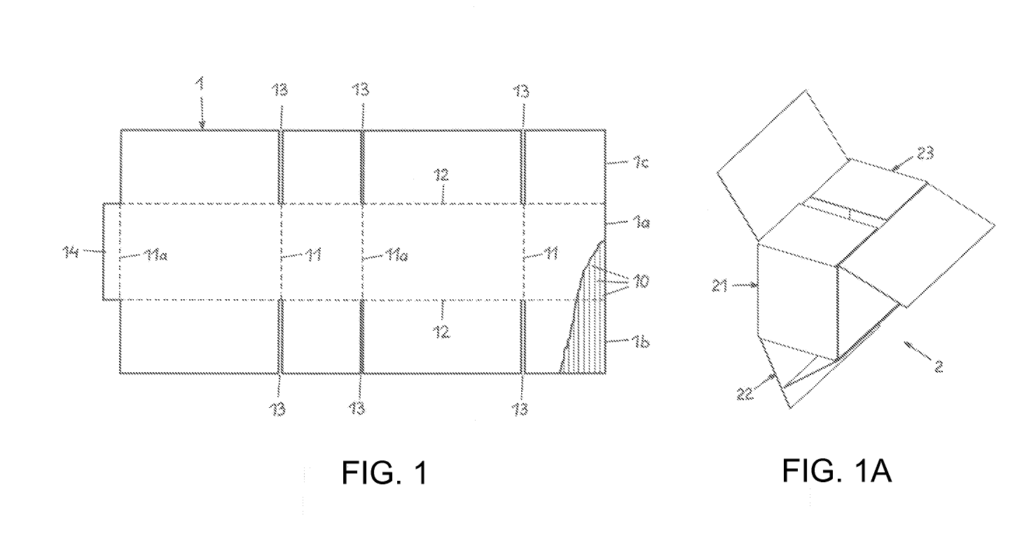

Referring now to the figures of the drawing in detail and first, particularly, to FIG. 1 thereof, there is shown a blank 1 which is used for the production of a cuboid folding box 2, shown in FIG. 1A. The blank 1, which is formed approximately rectangularly, consists of a single-corrugated board. The course of the corrugations 10 in the corrugated board is illustrated on the right-hand side of the blank 1. The central region 1a of this blank 1 is used to form the peripheral face 21 of the folding box 2, the lower region 1b is used to produce the bottom face 22, and the upper region 1c is used to produce the top face 23 of the folding box 2.

In order to form the peripheral face 21 of the folding box 2 by means of folding or bending the blank 1 and, furthermore, to join the peripheral face 21 at its two ends, the blank 1 is formed with four grooves 11 and 11a running at least approximately parallel to the corrugations 10 of the corrugated board. In extension of these grooves 11 and 11a, there are slots 13 in the lower region 1b and in the upper region 1c. On account of these grooves 11 and 11a and the slot 13, the central part 1a can be folded or bent along the grooves 11 and 11a.

Furthermore, between the central region 1a and the lower region 1b and, respectively, the upper region 1c, the blank 1 is formed with a groove 12 in each case running approximately perpendicular to the course of the corrugations 10. The groove 12 allows the four sections of the lower region 1b and of the upper region 1c to be bent with respect to the central region 1a in order in this way to form the bottom face 22 and the top face 23 of the folding box 2, respectively. Furthermore, the left-hand end of the central region 1a is formed with a flap 14 with which, by folding the blank 1 along the grooves 11, the right-hand end of the central region 1a comes into contact and is joined to the latter, for example by way of adhesive bonding, which produces the intrinsically closed peripheral face 21.

Blanks 1 of this type for folding boxes are prefabricated to the effect that they are folded along the grooves 11 and that the peripheral face 21 is intrinsically closed by producing a closure, for example by means of adhesive bonding. In this way, two-layer semifinished products are created, which are stacked on pallets and transported by means of the latter. In order to produce folding boxes 2 from these semifinished products, the semifinished products have to be folded along the grooves 11, bends through 90° have to be made along the grooves 11a, and the parts for producing the bottom face 22 and the top face 23 likewise have to be bent respectively through 90° with respect to the peripheral face 21, by which means the folding boxes 2 are finished and can be filled with the top face 23 open.

Since, in the region of the peripheral face 21, the corrugations 10 are aligned such that they run from the bottom face 22 to the top face 23 of the folding box 2, the required high stacking strength of the folding boxes is achieved.

During the production of such semifinished products, the effect occurs that the folds along the grooves 11, which are made parallel to the course of the corrugations 10, can be located in the region of a corrugation peak, a corrugation valley or the flank located between the latter, as a result of which, because of the different natures of the material, the folds can deviate from the predefined line. This effect is designated “fishtailing.” As a result of these deviations in the folds, deviations also occur when closing the peripheral face of the individual blanks. This effect is designated a “gap.” On account of these effects, the folding boxes produced from corrugated board exhibit only a low degree in dimensional accuracy.

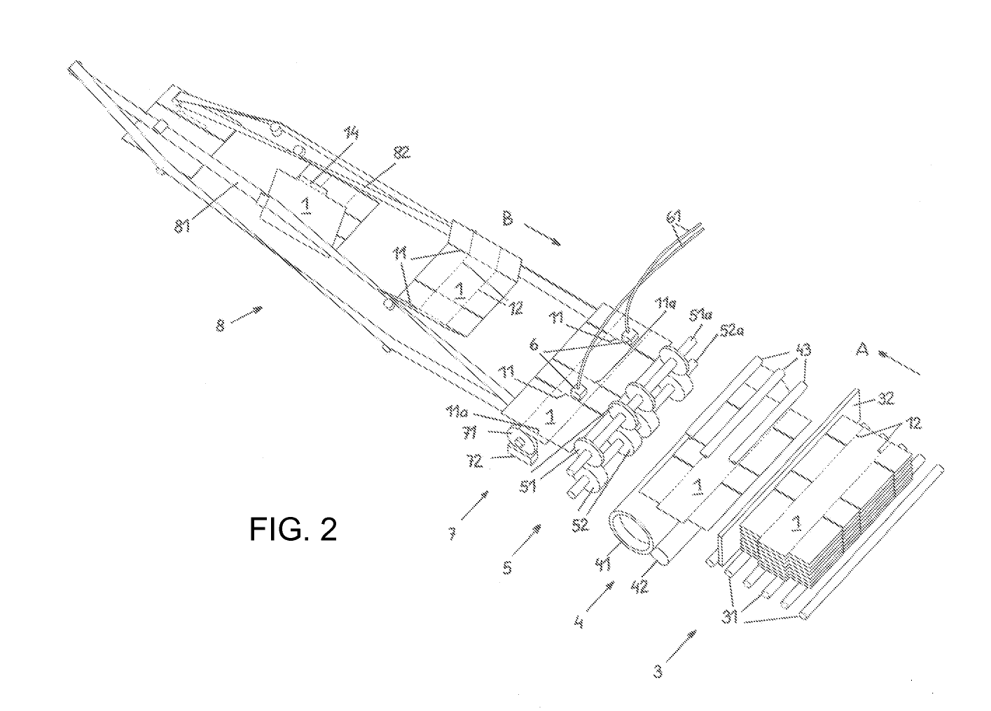

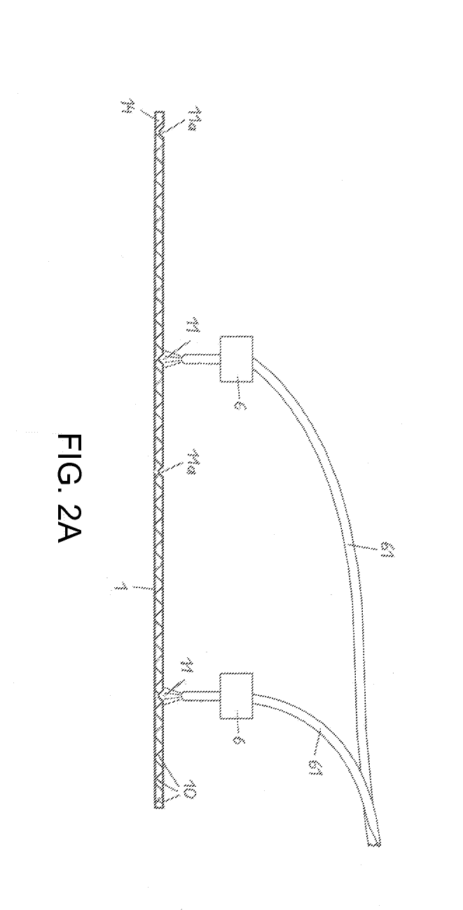

Employing the assembly system of FIG. 2, however, for producing the folding blanks avoids these disadvantages, as explained in the following.

The system illustrated in FIG. 2 has an apparatus 3 which is used to feed blanks 1, which consist of corrugated board and are located in a stack and have the formation according to FIG. 1 but not with grooves 11 and 11a running parallel to the corrugations 10 for the production of the peripheral face 21, individually in the direction of movement A to processing. These blanks 1 are located on conveyor rolls 31, by means of which in each case a blank 1 is fed to processing under a barrier 32. The blanks 1 are guided through a printing station 4, in which they are printed. The printing station 4 has a printing roll 41, an inking roll 42 and pressure rolls 43.

After the printing station 4, the blanks are fed to an apparatus 5 for producing the grooves 11 and 11a running parallel to the corrugations 10.

The apparatus 5 comprises four upper discs 51, which are fixed to a shaft 51a and are rotated by means of the shaft 51a. The four upper discs 51 are assigned four lower discs 52 supporting the blanks 1, which are fixed to a shaft 52a and are rotated by the latter. By means of the upper discs 51, the grooves 11 and 11a which run parallel to the corrugations 10 are impressed into the blanks 1.

The apparatus 5 has two spray nozzles 6 arranged downstream, to which a liquid is fed via lines 61 and by way of which the liquid is sprayed into the grooves 11. Use is made here of a liquid that penetrates the corrugated board quickly. The blanks 1 are then folded along the grooves 11 such that two-layer semifinished products are produced, which can be stacked on a pallet. Furthermore, the peripheral faces are intrinsically closed.

In FIG. 2A, the blank 1, the grooves 11 and 11a running along the corrugations 10 in the latter, and the spray nozzles 6 assigned to the grooves 11 are shown.

The fact that a liquid which penetrates the corrugated board is sprayed into the grooves 11 means that the corrugated board in the region of the grooves 11 becomes so flexible that the subsequent folding operation along these grooves 11 can be carried out exactly along the predefined line, irrespective of the region of the corrugations in which the folding is carried out, which means that the blanks 1 are folded exactly in the required manner and thus the “fishtailing” effect is avoided.

Also arranged in the movement path of the blanks 1 is an apparatus 7 for applying an adhesive to the flap 14. The apparatus 7 has a roll 71, by means of which adhesive located in a container 72 is applied to the flap 14.

The blanks 1 processed in this way are then fed to an apparatus 8 to fold said blanks along the grooves 11.

The apparatus 8 has a conveying apparatus, such as a conveyor belt, by means of which the blanks are conveyed onward in the conveying direction A. The conveying apparatus is assigned two belts 81 and 82 moved at the speed of the conveying apparatus, which are guided in such a way that they come into contact with the sections of the blanks 1 lying laterally outside the grooves 11, these sections being folded toward each other along the grooves 11 over the region in between during their movement in the direction of the arrow A. In the process, the folded-over outer face of the right-hand end of the blank 1 reaches the flap 14, which is coated with an adhesive, so that the two end parts of the peripheral face 21 are joined to each other, by which means the peripheral face 21 of the folding box 1 becomes intrinsically closed. The fact that the folds along the grooves 11 are made along the predefined lines means that the peripheral faces 21 are closed exactly in the required way. In this way, a very high dimensional accuracy of the folding boxes 2 in relation to the internal dimensioning thereof is achieved.

The two-layer and intrinsically closed semifinished products produced in this way are then stacked on pallets and supplied to the users on the latter.

For the use as a container for goods, these semifinished products are unfolded along the grooves 11 to form prismatic bodies and bent along the grooves 11a. Furthermore, the sections of the bottom face 22 are bent along the predefined grooves 12 such that the folding box 2 formed with a bottom is produced, which can subsequently be filled. Following their filling, the sections of the top face 23 are also bent with respect to the peripheral face 21, by which means the folding box 2 is closed.

The folding lines and bending lines can be formed by grooves, scores, perforations or the like.

In such a system, apparatuses can be provided for the complete processing of corrugated board. Likewise, the system can also be fed with already largely processed blanks.

It is important to the invention that the corrugated board is made flexible by wetting in the regions of fold lines aligned at least approximately parallel to the course of the corrugations of the corrugated board before the folding operation for the production of a semifinished product, as a result of which the folding is carried out exactly along the predefined fold lines, as a result of which the closure of the peripheral face is made at the correct point.

In order to wet the corrugated board, use is made of a liquid by which the corrugated board is penetrated quickly and which subsequently evaporates. Rapid penetration of the corrugated board is required since such systems operate at high speeds and it is necessary to ensure that the corrugated board in the region of the grooves and the like is made sufficiently flexible for the folding operations, in order that these can be carried out exactly along the predefined lines.

Liquids that are suitable for the wetting of the corrugated board are, inter alia, mixtures of water and alcohols, such as ethanol or petroleum ether (surgical spirit), wherein the proportion of water is 20% by volume to 80% by volume, preferably about 50% by volume, and the proportion of alcohol is 80% by volume to 20% by volume, preferably about 50% by volume. In particular, distilled water is used.

1. A method for folding blanks of corrugated board for the production of folding boxes, the method which comprises:
providing the folding blanks with fold-line structuring defining folding locations at which the corrugated board is to be folded or bent, the fold-line structuring being selected from the group consisting of grooves, scores, and perforations aligned substantially parallel to, or perpendicular to, a course of corrugations of the corrugated board;
applying a liquid to at least some of the fold-line structuring prior to a folding operation to thereby render the corrugated board relatively more flexible at the respective fold-line structuring than remaining parts of the corrugated board.

2. The method according to claim 1, which comprises spraying the liquid directly into the fold-line structuring.

3. The method according to claim 1, which comprises applying a liquid that is capable of penetrating the corrugated board within a relatively short time.

4. The method according to claim 1, wherein the liquid used is a mixture of water and an alcohol, such as ethanol or petroleum ether, with the water content having a proportion of 20% by volume to 80% by volume, and the alcohol content having a proportion from 80% by volume to 20% by volume of the mixture.

5. The method according to claim 4, wherein the mixture of water and an alcohol has approximately 50% water and 50% alcohol by volume.

6. The method according to claim 4, wherein the alcohol is selected from the group consisting of ethanol and petroleum ether.

7. The method according to claim 4, which comprises using distilled water.

8. An assembly for folding blanks for the production of folding boxes of corrugated board, the blanks having fold-line structuring defining folding locations at which the corrugated board is to be folded or bent, the fold-line structuring being selected from the group consisting of grooves, scores, and perforations aligned substantially parallel to, or perpendicular to, a course of corrugations of the corrugated board, and the assembly comprising:
a folding apparatus for folding the blanks along some of the fold-line structuring;
at least one liquid application apparatus for introducing a liquid into the fold-line structuring prior to folding the blanks, disposed upstream of the folding apparatus for folding the blanks in a process flow direction.

9. The system according to claim 8, wherein said at least one liquid application apparatus is configured to spray the liquid into the grooves, scores, and/or perforations.

10. The system according to claim 8, wherein said at least one liquid application apparatus is configured to introduce a liquid by which the corrugated board is penetrated within a short time.

11. The system according to claim 8, wherein said at least one liquid application apparatus is configured to apply a mixture of water and an alcohol.

12. The system according to claim 11, wherein the alcohol is ethanol or petroleum ether.

13. The system according to claim 8, wherein the liquid consists of 20% by volume to 80% by volume of water and 80% by volume to 20% by volume of alcohol.

14. The system according to claim 13, wherein the liquid consists of 50% by volume of water and 50% by volume of alcohol.

15. The system according to claim 13, wherein the water is distilled water.

16. The system according to claim 8, which comprises an apparatus for forming the fold-line structures in substantial alignment in parallel with the course of the corrugations in the blanks.

17. The system according to claim 8, which comprises a joining apparatus for joining together two mutually assigned end parts of a peripheral face of the folding box.

18. The system according to claim 17, which further comprises a glue applicator apparatus for applying an adhesive to at least one of the two mutually assigned end parts of the peripheral face of the folding box for closing the peripheral face, and wherein said joining apparatus is configured for folding the peripheral face and to bring the mutually assigned end parts of the peripheral face into contact with one another and adhesively bonded to one another as a result.
